(19) United States
(12) Patent Application Publication
(10) Pub. No.: US 2024/0134124 A1
(43) Pub. Date: Apr. 25, 2024

(54) IMAGE DISPLAY DEVICE, HEAD-UP DISPLAY EQUIPPED WITH IMAGE DISPLAY DEVICE, AND MOVABLE BODY

(71) Applicant: Panasonic Intellectual Property Management Co., Ltd., Osaka (JP)

(72) Inventor: Shunsuke Tomomatsu, Osaka (JP)

(21) Appl. No.: 18/403,911

(22) Filed: Jan. 4, 2024

Related U.S. Application Data
(63) Continuation of application No. PCT/JP2022/014515, filed on Mar. 25, 2022.

(30) Foreign Application Priority Data
Jul. 8, 2021 (JP) 2021-114326

(51) Int. Cl. G02B 6/32; G02B 6/42; G02B 19/00; G02B 27/01

(52) U.S. Cl. CPC G02B 6/327; G02B 6/003; G02B 6/4269; G02B 19/0052; G02B 27/0101; G02B 2027/0154; G02B 2207/101

(57) ABSTRACT

An image display device includes a light source, a display panel, and a light guide. The light source has a light source element that irradiates light. The display panel displays an image, and the light guide guides light from the light source to the display panel. The light guide has a lens portion that suppresses spread of light from the light source part. A maximum spread angle θ at which light irradiated from the light source intersects with a main plane of the lens portion being 15 degrees or more and 60 degrees or less. Light irradiated from the light source has a width less than one-third of the width of the main plane of the lens portion.

### CROSS REFERENCE TO RELATED APPLICATION

This is a continuation application of International Application No. PCT/JP2022/014515, with an international filing date of Mar. 25, 2022, which claims priority of Japanese Patent Application No. 2021-114326 filed on Jul. 9, 2021, the content of which is incorporated herein by reference.

### BACKGROUND

### Technical Field

The present disclosure relates to an image display device using a light guide plate, a head-up display equipped with this image display device, and a movable body.

### Background Art

In WO2017094209, light rays emitted from a light source are guided to a display panel by using a light guide plate. Light leaving the light guide plate is incident on the display panel with light distribution angles that differ in the long-side direction and the short-side direction of the display panel, by virtue of a light ray control part and a light ray deflecting member.

In an eyebox where an observer can visually recognize a virtual image, light needs to be diffused in the long-side direction. However, if light is diffused also in the short-side direction in unison with the long-side direction, the brightness in the short-side direction lowers. Although the light distribution angle in the short-side direction is smaller than that in the long-side direction due to the light distribution angles differing in the long-side direction and the shot-side direction, there still remains the amount of light spreading beyond the range of the eyebox.

### SUMMARY

An object of the present disclosure is to provide an image display device having an eyebox with increased amount of light, a head-up display equipped with the image display device, and a movable body.

An image display device of the present disclosure includes: a light source having a light source element that irradiates light; a display panel that displays an image; and a light guide that guides light from the light source to the display panel. The light guide has a lens portion that suppresses spread of light from the light source part. A maximum spread angle θ at which light irradiated from the light source intersects with a main plane of the lens portion is 15 degrees or more and 60 degrees or less. Light irradiated from the light source has a width less than one-third of the width of the main plane of the collimate lens portion.

A head-up display of the present disclosure includes the image display device described above.

A movable body of the present disclosure includes the head-up display described above.

The present disclosure can provide an image display device having an eyebox with increased amount of light, a head-up display equipped with the image display device, and a movable body.

### BRIEF DESCRIPTION OF DRAWINGS

FIG. 1 is a schematic diagram of a vehicle equipped with a head-up display in a first embodiment.

FIG. 2 is a schematic diagram of a section of the image display device in the first embodiment.

FIG. 3 is a schematic diagram, in plan view, of the image display device in the first embodiment.

FIG. 4A is a partial enlarged section view of a light source and its vicinity in the first embodiment.

FIG. 4B is a sectional view showing a configuration of the light source in the first embodiment.

FIG. 5A is a sectional view showing a pupil diameter of emission light from a light source element.

FIG. 5B is an explanatory view showing an eyebox in the first embodiment.

FIG. 6 is a view showing an illuminance distribution of the eyebox in the first embodiment.

FIG. 7 is a partial enlarged view of the light source element and its vicinity in a comparison example.

FIG. 8 is a view showing an illuminance distribution of the eyebox in the comparison example.

FIG. 9 is a schematic diagram of a partial section of a light guide panel in a variant of the first embodiment.

FIG. 10 is a schematic diagram of a section of an image display device in a second embodiment.

FIG. 11 is a partial enlarged sectional view of the image display device in the second embodiment.

FIG. 12 is a partial enlarged sectional view of an image display device in a first variant of the second embodiment.

FIG. 13 is a partial enlarged sectional view of an image display device in a second variant of the second embodiment.

FIG. 14 is a partial enlarged sectional view of an image display device in a third variant of the second embodiment.

FIG. 15 is a partial enlarged sectional view of an image display device in a fourth variant of the second embodiment.

### DETAILED DESCRIPTION

Embodiments will now be described in detail with appropriate reference to the drawings. However, more detailed description than necessary may be omitted. For example, detailed description of already well-known matters and duplicate description for substantially the same configuration may be omitted. This is to avoid unnecessary redundancy in the following description and to facilitate the understanding of those skilled in the art.

It should be noted that the inventors provide the accompanying drawings and the following description in order that those skilled in the art fully understand the present disclosure, but do not intend to thereby limit the subject matter described in the claims.

### First Embodiment

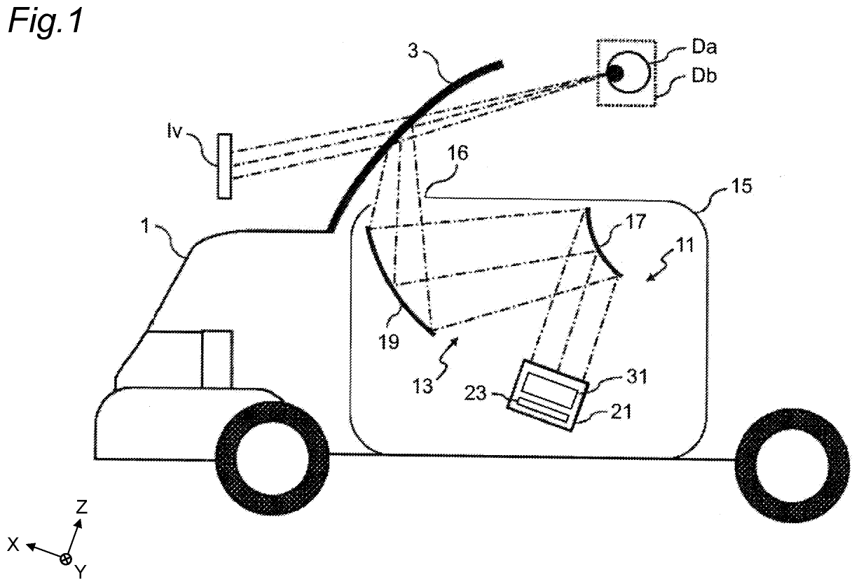

Referring to FIGS. 1 to 8, an image display device according to this embodiment of the present disclosure will hereinafter be described.

[1-1. Overview]

FIG. 1 is a schematic diagram of a vehicle 1 equipped with a head-up display 11 in this embodiment. The vehicle 1 as a movable body is for example an automobile. For example, a driver as an observer Da rides in the vehicle 1. The vehicle 1 includes a windshield 3 that is a transparent member.

Light emitted from a display panel 31 of the head-up display 11 is guided via the windshield 3 into an eyebox Db of the observer Da. Thereby, the observer Da visually recognizes a virtual image Iv. Note that the eyebox Db is an area where the observer Da can see the virtual image without missing it.

[1-2. Configuration]

[1-2-1. Configuration of Head-Up Display]

The head-up display 11 includes an image display device 21 and a reflection optical unit 13. The head-up display 11 is disposed within a housing 15. It is to be noted that in FIG. 1, to facilitate understanding, the head-up display 11 and the housing 15 are depicted in an enlarged manner. The configuration of the image display device 21 will be described later.

The reflection optical unit 13 includes a first mirror 17 and a second mirror 19. The first mirror 17 reflects light emitted from the display panel 31 of the image display device 21 described later toward the second mirror 19. The second mirror 19 reflects light from the first mirror 17 toward the windshield 3. The shape of the reflective surface of the second mirror 19 is concave. The reflection optical unit 13 need not necessarily be composed of two mirrors. The number of mirrors may be one, or three or more. The reflection optical unit 13 may include a dioptric system such as lenses on the optical path.

The housing 15 has an opening 16. The opening 16 may be covered with a transparent cover.

[1-2-2. Configuration of Image Display Device]

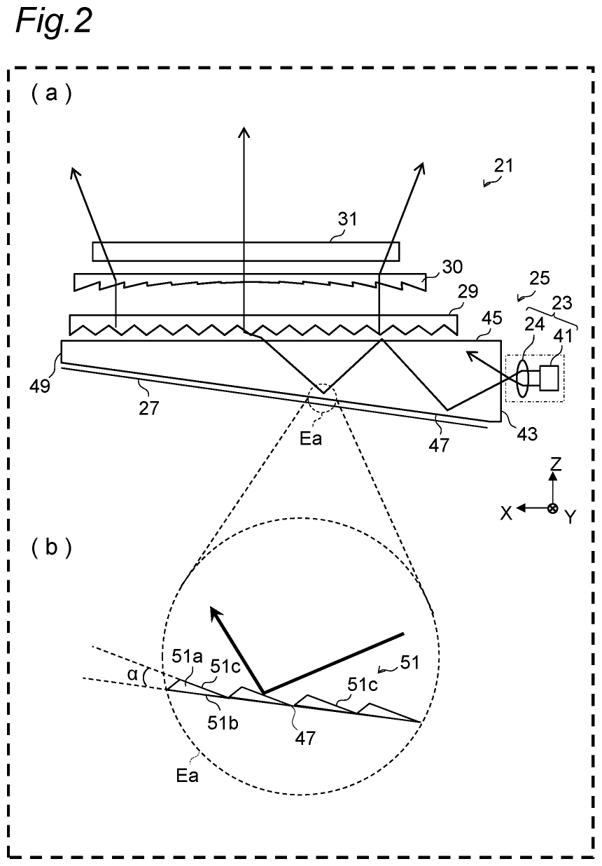

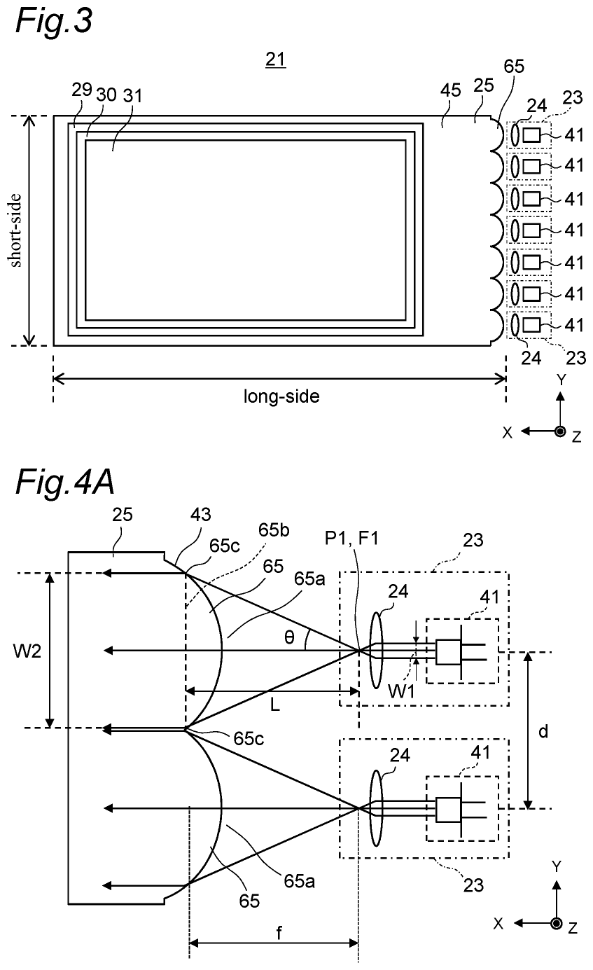

Referring to FIGS. 2 and 3, a configuration of the image display device 21 of the first embodiment will hereinafter be described. FIG. 2 is a schematic diagram of a section of the image display device 21 in the first embodiment. This section is an XZ section. FIG. 3 is a schematic diagram, in plan view, of the image display device 21 in the first embodiment. In the diagrams, Y-axis direction is a first direction, which is the short-side direction of the display panel 31, X-axis direction is a second direction, which is the longitudinal direction of the display panel 31, and Z-axis direction is a direction perpendicular to an XY plane.

The image display device 21 includes a light source 23 that irradiates light, a condenser lens 24, a light guide panel 25, a specular reflection member 27 acting as a reflective member, a light ray direction altering member 29, a light orientation lens 30, and the display panel 31 that displays images.

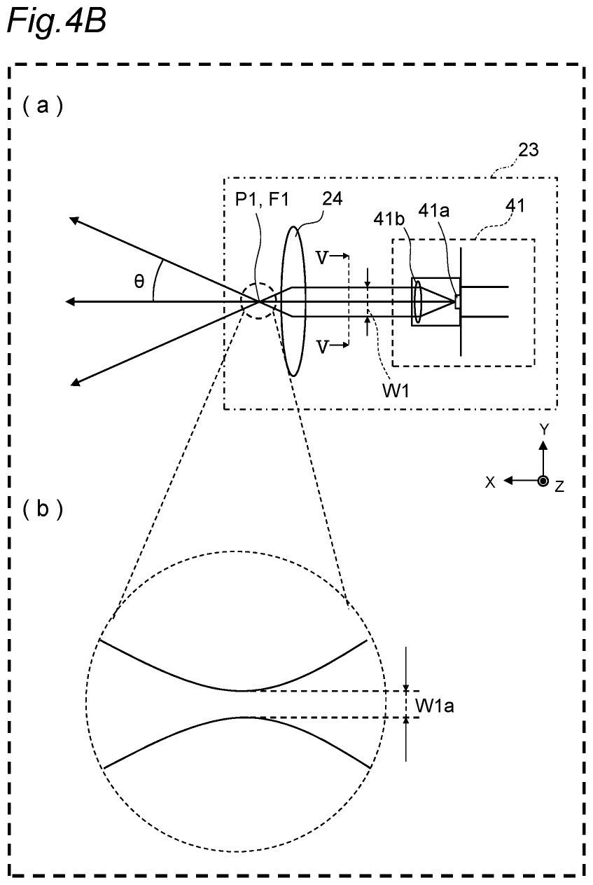

The light source 23 includes a plurality of light source elements 41. The plurality of light source elements 41 are arrayed in a row in a first direction (Y-axis direction) with respect to the image display device 21. The light source element 41 has a light emitting element 41a (see FIG. 4B) that supplies illumination light to the display panel 31 of a transmissive type.

The condenser lens 24 condenses light irradiated from the light source 23 at a predetermined position apart a predefined length from the light guide panel 25. The condenser lens 24 is for example a convex lens. Light condensed at the predetermined position diffuses again and enters an incident surface 43 of the light guide panel 25.

The light guide panel 25 guides light irradiated from the light source 23 to the display panel 31. The light guide panel 25 is arranged facing the plurality of light source elements 41 in a second direction (X-axis direction). The light guide panel 25 is made of resin for example and is arranged in proximity to the light source elements 41 leaving therebetween an enough space to avoid deformation due to heat of the light source elements 41. The light guide panel 25 is composed of a plurality of transparent plates that guide light. The light guide panel 25 has the incident surface 43, an exit surface 45, a bottom surface 47, and a confronting surface 49. The incident surface 43 and the confronting surface 49 are surfaces that face each other, and the exit surface 45 and the bottom surface 47 are surfaces that face each other. The incident surface 43 and the confronting surface 49 are side surfaces of the display panel 31 and each intersect with the exit surface 45 and the bottom surface 47. In this embodiment, the first direction is also a direction perpendicular to the light guiding direction of the incident surface 43 and the light exiting direction.

Light from the light source elements 41 enters the incident surface 43. The incident surface 43 has a rectangular shape when viewed from the light incident direction. The longitudinal direction of the incident surface 43 is the first direction (Y-axis direction). The incident surface 43 is one end surface of the light guide panel 25 in the second direction (X-axis direction) perpendicular to a third direction (Z-axis direction) in which the display panel 31 and the light guide panel 25 are stacked.

The confronting surface 49 confronts the incident surface 43. The exit surface 45 is arranged in a direction intersecting with the incident surface 43 and the confronting surface 49. Light incident on the incident surface 43 is emitted from the exit surface 45. The exit surface 45 is a surface defined by the first direction and the second direction orthogonal to the first direction. The exit surface 45 confronts the display panel 31.

The bottom surface 47 confronts the exit surface 45. The bottom surface 47 is inclined with respect to the exit surface 45. The interval between the bottom surface 47 and the exit surface 45 becomes narrower the farther away from the incident surface 43. Since the interval between the bottom surface 47 and the exit surface 45 gradually narrows, the shape of a section (XZ section) defined by the second direction and the third direction, of the light guide panel 25 is a wedge. As shown in FIG. 2(b), the bottom surface 47 is formed with a prism surface 51. FIG. 2(b) is a partial enlarged view of a section of the bottom surface 47 of the light guide panel 25. An enlarged view of a portion Ea of the bottom surface 47 shown in FIG. 2(a) is depicted in FIG. 2(b).

The prism surface 51 has a plurality of prisms 51a. The prism 51a has a wedged shape for example. The prism 51a has a slant surface 51c slanting from a surface 51b of the prism surface 51 toward the exit surface 45. An angle α between the slant surface 51c and the surface 51b is preferably 5 degrees or less. By virtue of the prisms 51a, the reflection angle of light rays reflected at the bottom surface 47 becomes larger. This allows light rays reflected at the bottom surface 47 to easily deviate from the total internal reflection condition at the exit surface 45, achieving increase in the amount of light emitted from the exit surface 45.

The specular reflection member 27 is arranged along the light guide panel 25 at least on the opposite side to the exit surface 45, i.e., on the side of the bottom surface 47. The specular reflection member 27 reflects light again inward of the light guide panel 25 when light entering the light guide panel 25 from the incident surface 43 tries to leave from the bottom surface 47. Desirably, the material of the specular reflection member 27 has as high a reflectance as possible. The material of the specular reflection member 27 is preferably a metal. The specular reflection member 27 is formed e.g., by sticking a metal sheet onto the bottom surface 47 of the light guide panel 25.

The exit surface 45 of the light guide panel 25 is of a rectangular shape consisting of long sides and short sides, with the plurality of light source elements 41 arranged in a row along the short-side direction of the exit surface 45 in plan view.

The light ray direction altering member 29 is arranged on the exit side of the light guide panel 25. That is, the light ray direction altering member 29 is arranged between the light guide panel 25 and the display panel 31. The light ray direction altering member 29 alters the traveling direction of the entire light emitted from the light guide panel 25 toward the direction where the display panel 31 lies. The light ray direction altering member 29 has a row of triangular prisms on its surface facing the exit surface 45 of the light guide panel 25. The shape of these triangular prisms is a triangular prism shape with a central axis parallel to the first direction. These triangular prisms are arranged in the second direction. The apex angle of the triangular prism is preferably approx. 60 degrees. The light ray direction altering member 29 deflects light launched toward the third direction by the triangular prisms so as to become perpendicular to the exit surface, thereby improving the frontal brightness.

The light orientation lens 30 orientates the traveling direction of light from the light ray direction altering member 29 with respect to the display panel 31. The light orientation lens 30 has different orientation directions at a central portion and peripheral portions. The light orientation lens 30 is, for example, a concave Fresnel lens. The light orientation lens 30 adjusts the direction of light incident on the display panel 31 toward the reflection optical unit 13.

Light rays emitted from the light guide panel 25 to the light ray direction altering member 29 rise toward the third direction. Since light rays are emitted from the exit surface 45 of the light guide panel 25 at an angle that violates the total internal reflection condition, this emitted light has an angle of 60 to 70 degrees with respect to the third direction. By setting the apex angle of the triangular prism to approx. 60 degrees, the highest brightness can be obtained when the image display device 21 is viewed from the third direction.

The transmissive display panel 31 is arranged on the exit side of the light ray direction altering member 29. The transmissive display panel 31 is, for example, a thin film transistor (TFT) transmissive display panel 31 of a dot matrix display type. An image emitted from the display panel 31 may be either a still image or a moving image. The image shows, for example, the traveling direction guidance for the vehicle 1 or the state of the vehicle 1.

The material of the light guide panel 25 and the light ray direction altering member 29 is a transparent material having a predefined refractive index. The refractive index of the transparent material is, for example, of the order of 1.4 to 1.6. Such a transparent material can be resin such as epoxy resin, silicon resin, acrylic resin, or polycarbonate. For example, considering the heat-resistant property, this embodiment uses polycarbonate.

In this embodiment, the image display device 21 is used for the head-up display 11 in which the range of the eyebox Db is relatively limited. In other words, light emitted from the image display device 21 has a relatively high directivity. A material substantially not containing any scattering agent is used as the material of the light guide panel 25. This allows light rays having a directivity to be guided while iterating the reflection within the interior of the light guide panel 25.

[1-2-3. Positional Configuration Between Light Guide Panel and Light Source]

A configuration of the incident surface 43 between the light guide panel 25 and the light source 23 of the first embodiment will hereinafter be described in detail with reference to FIGS. 4A and 4B. FIG. 4A is a partial enlarged sectional view of the light source 23 and its vicinity in the first embodiment. FIG. 4B is a sectional view showing a configuration of the light source 23 in the first embodiment, with FIG. 4B(a) being a sectional view of the light source element 41 and its vicinity in the first embodiment, FIG. 4B(b) being an enlarged view of a light condensing position P1 and its vicinity. The sections shown in FIGS. 4A and 4B are planes defined by the first and second directions, i.e., XY sections.

The light source element 41 has a light emitting element 41a that emits light, and a collimate lens 41b that collimates light emitted from the light emitting element 41a. The light emitting element 41a is a light emitting element having a light-emitting surface smaller than that of a chip-type light emitting diode (LED), for example, a laser light emitting element.

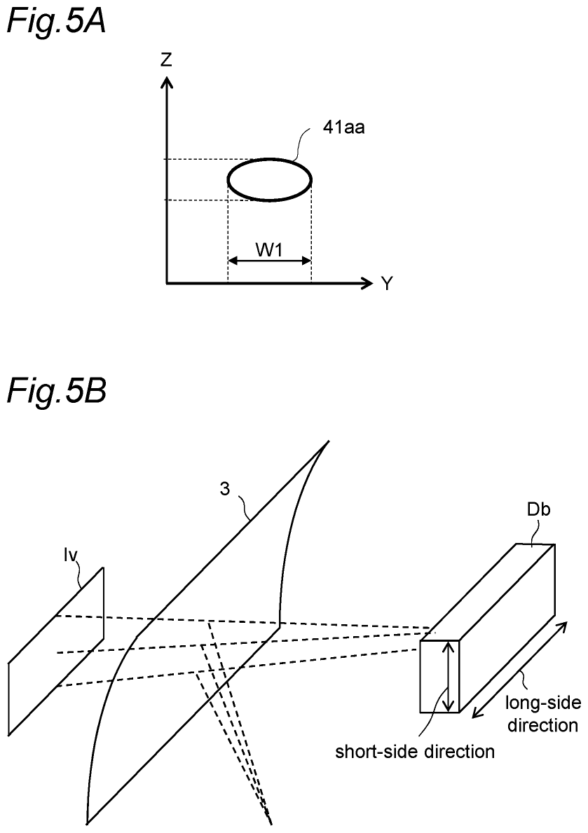

Light emitted from the light emitting element 41a is collimated by the collimate lens 41b and emitted from the light source element 41. A width W1 of this collimated light is a width in the long-axis direction (Y-axis direction) of a pupil diameter, as shown in FIG. 5A.

Light emitted from the light emitting element 41a is condensed at the light condensing position P1 by the condenser lens 24 and thereafter again expanded. In the case of using the laser light emitting element as the light emitting element 41a, the width of light irradiated from the light source 23 means a width W1a of the pupil diameter of light in the long-axis direction at the light condensing position P1. The smaller the size of the light-emitting surface of the light emitting element 41a is, the smaller the width W1a of light at the light condensing position P1 becomes. The width W1a of light at the light condensing position P1 is less than 1 mm, for example, equal to or less than 0.5 mm. The width W1a of light in the case where the light source 23 has no condenser lens 24 is a width W1 of light when emitted from the light source element 41.

Reference is made to FIG. 4A. The incident surface 43 of the light guide panel 25 has a plurality of convex collimate lens portions 65 each corresponding to each of the light source elements 41. The collimate lens portions 65 each have a convex surface 65a that is a curved surface that protrudes and curves facing each of the light source elements 41. And, each convex surface 65a has a curvature center axis that is perpendicular to the XY plane. That is, the curvature center axis of each convex surface 65a is parallel to the third direction (Z-axis direction). The shape of each collimate lens 41b is, for example, a cylindrical shape, and is a semi-cylindrical shape with its central axis that is a straight line parallel to the third direction. The third direction is a direction orthogonal to both the first direction and the second direction. The plurality of collimate lens portions 65 are arrayed in the first direction. Each of the collimate lens portions 65 is formed integrally with the light guide panel 25. The plurality of collimate lens portions 65 are arranged corresponding to light irradiated from each of the plurality of light source elements 41.

The light condensing position P1 of light passing through the condenser lens 24 coincides with a focal position F1 of the collimate lens portion 65. As used herein, coincidence between the light condensing position P1 and the focal position F1 includes not only the case of completely coinciding with each other but also the case where the light condensing position P1 and the focal position F1 lie close to each other. For example, let Lpf be the positional offset amount between the light condensing position P1 and the focal position F1. Then, the light condensing position P1 and the focal position F1 need only be close to each other to such a degree that the positional offset amount Lpf satisfies the following relational expression using a focal length f of the collimate lens portion 65:

−f/5<Lpf<f/5 (1)

Pitch d between the adjacent light source elements 41, length L from the light condensing position P1 of light passing through the condenser lens 24 to a main plane 65b of the collimate lens portion 65 of the light guide panel 25, and maximum spread angle 9 of light from the focal position F1 satisfy the following relational expression. The main plane 65b of the collimate lens portion 65 is a plane joining intersections 65c between light diverging at the maximum spread angle θ from the light source 23 and the collimate lens portion 65. The maximum spread angle θ is a spread angle relative to the optical axis.

1.6·L·tan θ≤d≤2.0·L·tan θ (2)

If this relationship is satisfied, the display panel can be evenly irradiated.

The maximum spread angle θ at which light irradiated from the light source 23 intersects with the main plane 65b of the collimate lens portion 65 is 15 degrees or more and 60 degrees or less. The width W1a of light irradiated from the light source 23 is smaller than one-third of a width W2 of the main plane 65b of the collimate lens portion 65. By reducing the width W1a of light irradiated from the light source 23 so as to satisfy such a relationship, light irradiated from the light source 23 can be efficiently collimated by the collimate lens portion 65.

Describing in more detail, if the maximum spread angle θ at which light irradiated from the light source 23 intersects with the main plane 65b of the collimate lens portion 65 is 15 degrees or more and less than 30 degrees, the width W1a of light irradiated from the light source 23 may be smaller than one-third of the width W2 of main plane 65b of the collimate lens portion 65. If the maximum spread angle θ is 30 degrees or more and less than 45 degrees, the width W1a of light irradiated from the light source 23 may be smaller than one-fourth of the width W2 of the main plane 65b of the collimate lens portion 65. If the maximum spread angle θ is 45 degrees or more and less than 50 degrees, the width W1a of light may be smaller than one-fifth of the width W2 of the main plane 65b. If the maximum spread angle θ is 50 degrees or more and less than 55 degrees, the width W1a of light may be smaller than one-sixth of the width W2 of the main plane 65b. If the maximum spread angle θ is 55 degrees or more and less than 60 degrees, the width W1a of light may be smaller than one-seventh of the width W2 of the main plane 65b. For example, the width W1a of light, the width W2 of the main plane 65b, and the maximum spread angle θ satisfy the following relational expression.

W1a<W2/tan θ/4 (3)

If this relational expression is satisfied, light irradiated from the light source 23 can be more efficiently collimated by the collimate lens portion 65.

Referring next to FIGS. 5A and 5B, the pupil diameter of laser light emitted from the light source element 41 will be described. FIG. 5A is a sectional view taken along line V-V of FIG. 4B(a), and is a sectional view showing the pupil diameter of emission light from the light source element 41. FIG. 5B is an explanatory view showing the eyebox Db.

Using e.g., a semiconductor laser as the light emitting element 41a, laser light emitted from the light emitting element 41a is light having different pupil diameters in Y-axis direction and Z-axis direction. For example, laser light immediately after irradiation from the light source element 41 has a pupil diameter 41aa of an elliptical shape extending in Y-axis direction, with a long diameter in Y-axis direction and a short diameter in Z-axis direction. In laser light, a divergent angle of light in the long-diameter direction of the pupil diameter 41aa is smaller than that in the short-diameter direction. The eyebox Db has, for example, a shape where the length in the horizontal direction is longer than that in the vertical direction, as shown in FIG. 5B. Accordingly, in the eyebox Db, the horizontal direction is the long-side direction, and the vertical direction is the short-side direction. Thus, in order to allow the long-diameter direction of the pupil diameter 41aa with a smaller divergent angle to be the short-side direction (vertical direction) of the eyebox, the light source elements 41 are arranged so that the short-diameter direction of the pupil diameter 41aa becomes the long-side direction (horizontal direction) of the eyebox Db. This can suppress the spread of light in the short-side direction (vertical direction) of the eyebox Db, making it possible to reduce light deviating from the eyebox Db to improve the illuminance of the eyebox Db. Due to having the short diameter in Z-direction, the display panel can be illuminated more evenly.

[1-3. Effects, Etc.]

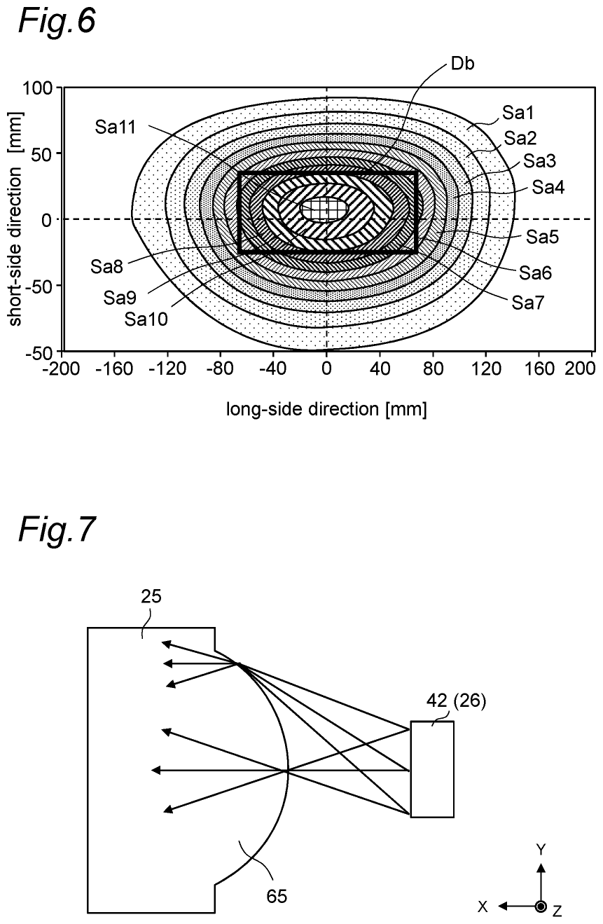

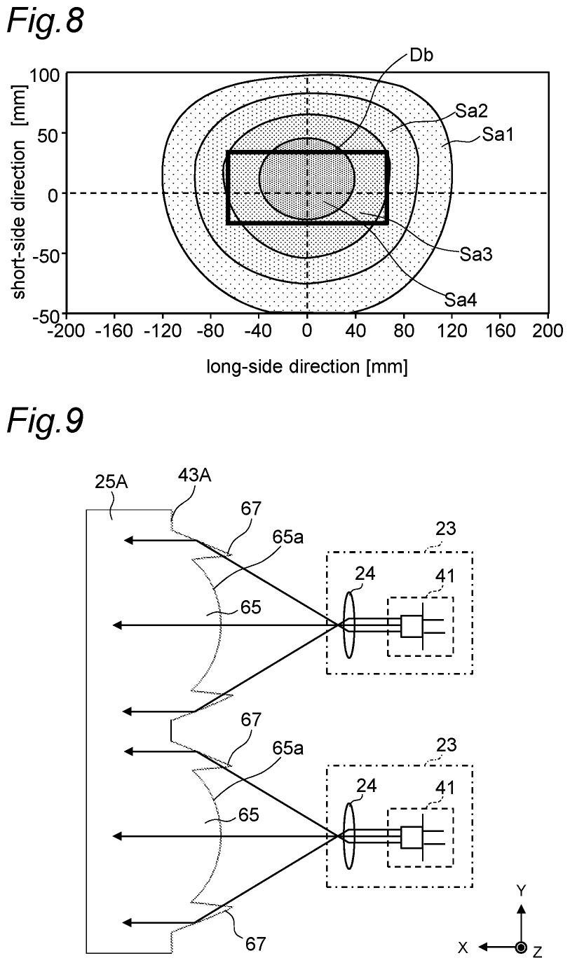

Referring to FIGS. 6 to 8, effects of the head-up display 11 of this embodiment will be described. FIG. 6 is a view showing an illuminance distribution inside the eyebox Db obtained by the head-up display 11 including the image display device 21 of this embodiment. FIG. 7 is a partial enlarged view of the light source element 41 and its vicinity in a comparison example. FIG. 8 is a view showing an illuminance distribution inside the eyebox Db obtained by a head-up display including an image display device of the comparison example.

As shown in FIG. 7, since a light source element 42 of a light source 26 of the comparison example has an LED for example and has a large light-emitting surface, the collimate lens portion 65 of the light guide panel 25 cannot completely collimate light irradiated from the light source element 42, allowing light to propagate while spreading. As a result, as shown in FIG. 8, the amount of light spreading outside of the eyebox Db increases, and the illuminance inside the eyebox Db reduces. In FIG. 8, an area Sa1 is an area whose illuminance is 3.7 or more and less than 7.4; an area Sa2 is an area whose illuminance of is 7.4 or more and less than 11.1; an area As3 is an area whose illuminance is 11.1 or more and less than 14.8; and an area Sa4 is an area whose illuminance is 14.8 or more.

On the other hand, the image display device 21 of this embodiment includes the light source 23 having the light source element 41 that irradiates light, the condenser lens 24 that condenses light irradiated from the light source 23, the display panel 31 that displays images, and the light guide panel 25 that guides light from the condenser lens 24 to the display panel. The light source element 41 has a light-emitting surface smaller than that of the light emitting diode.

Since this allows light with a small light-emitting surface from the light source 23 to be incident on the light guide panel 25, the spread of light can be suppressed and the amount of light propagating inside the eyebox Db can be increased. Thus, the image display device 21 having an increased amount of light can be provided.

As shown in FIG. 6, the illuminance inside the eyebox Db can be improved as compared with the comparison example. In the illuminance distribution of the eyebox Db of this embodiment, areas Sa5 to Sa11 are observed that have larger illuminance than the areas Sa1 to Sa4 in the illuminance distribution of the comparison example do. The area Sa5 is an area whose illuminance is 18.5 or more, the area Sa8 is an area whose illuminance is 29.6 or more, and the area Sa10 is an area whose illuminance is 40.7 or more.

In the case where particularly, light of the light source element 41 is incident from the short-side direction of the exit surface 45 of the light guide panel 25, it is different to suppress the spread of light in the vertical direction of the eyebox Db even by the light ray direction altering member 29 or the collimate lens portion 65 of the light guide panel 25. On the other hand, by using of the light source element 41 with a smaller light-emitting surface than that of the light emitting diode, it is possible to suppress the spread of light in the vertical direction of the eyebox Db and to improve the illuminance inside the eyebox Db.

Although in the eyebox Db, light needs to be diffused in the long-side direction that is the horizontal direction, the brightness in the short-side direction reduces if light is diffused also in the short-side direction that is the vertical direction similarly to the long-side direction. It is therefore desirable that the light distribution angle in the short-side direction of the eyebox Db be smaller than that in the long-side direction of the eyebox Db. In the case of using the laser element as the light source element 41, the divergent angle of light in the long-diameter direction of the pupil diameter of laser light is smaller than that of light in the short-diameter direction. Hence, by arranging the laser element so that the long-diameter direction of the pupil diameter of laser light emitted from the light source element 41 corresponds to the short-side direction of the eyebox Db, the spread of light in the short-side direction of the eyebox Db can be suppressed than in the long-side direction thereof.

In this embodiment, the head-up display 11 includes the image display device 21. This enables provision of the head-up display 11 having an increased amount of light.

In this embodiment, the vehicle 1 as the movable body includes the head-up display 11. This enables provision of the vehicle 1 that includes the head-up display 11 having an increased amount of light.

Referring next to FIG. 9, a variant of the light guide panel 25 of this embodiment will be described. FIG. 9 is a partial enlarged sectional view of the light source element 41 and its vicinity in the variant of the first embodiment. As shown in FIG. 9, an incident surface 43A has a protruding portion 67 that is in contact with an outer peripheral surface of each of the collimate lens portions 65 and extends toward the light source element 41. Since the protruding portion 67 is formed between the adjacent collimate lens portions 65, it can collimate light spreading in the width direction. The protruding portion 76 may be formed at an upper portion or a lower portion of the collimate lens portion 65, and in this case, it can collimate light spreading in the up-and-down direction.

Since by virtue of the protruding portion 67, light emitted from the light source element 41 can be more collimated, more light rays can be condensed within the light guide panel 25.

### Second Embodiment

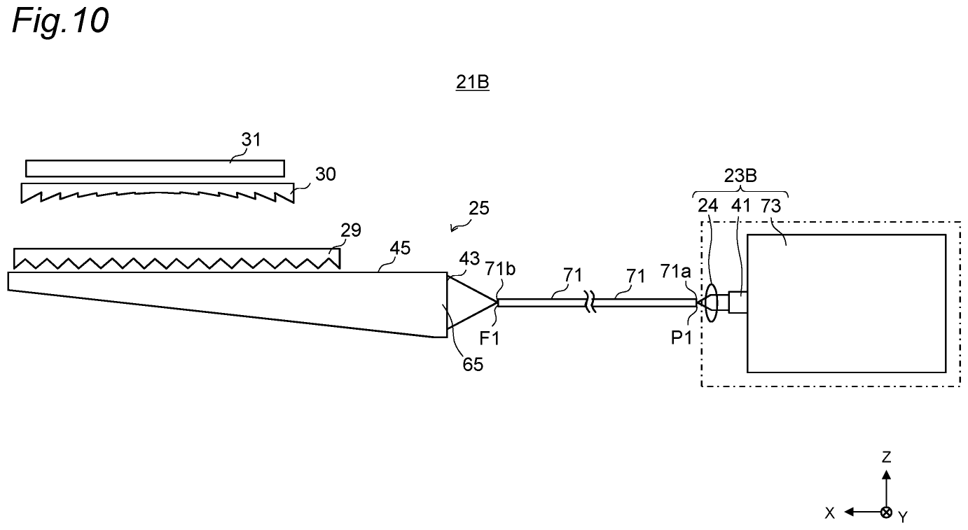

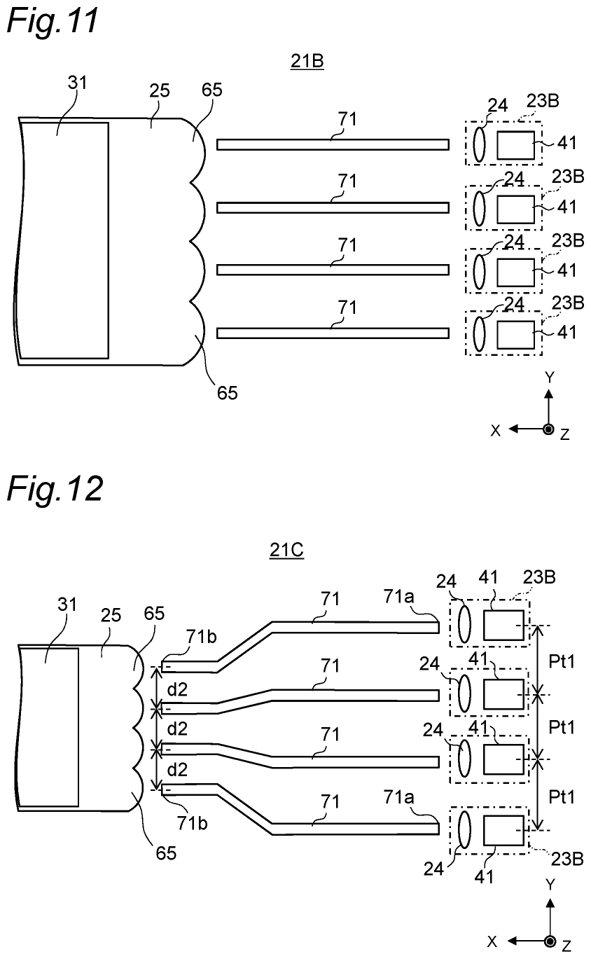

Hereinafter, referring to FIGS. 10 and 11, an image display device 21B of a second embodiment will be described. FIG. 10 is a schematic diagram of a section of the image display device in the second embodiment. FIG. 11 is a partial enlarged sectional view of a light source element and a light guide panel in the second embodiment. The image display device 21B of the second embodiment has an optical fiber arranged between the condenser lens 24 and the light guide panel 25. In the second embodiment, similar reference numerals are imparted to members having similar configurations and functions to those of the first embodiment, of which detailed explanations and of which descriptions of similar effects may be omitted.

[2-1. Configuration]

The image display device 21B includes a light source 23B, the condenser lens 24, the display panel 31, the light guide panel 25, and an optical fiber 71. The optical fiber 71 is arranged between the condenser lens 24 and the light guide panel 25 so that light from the condenser lens 24 propagates via the optical fiber 71 to the light guide panel 25. For example, the optical fiber 71 has an opening 71a toward the light source 23B, that is positioned at the light condensing position P1 of the condenser lens 24, and an exit opening 71b toward the light guide panel 25, that is positioned at the focal position F1 of the collimate lens portion 65 on the incident surface 43 of the light guide panel 25. The light source element 41 may have, for example, red, green, and blue laser elements. Thereby, each light source element 41 can emit laser light of three different colors.

Since the optical fiber 71 allows the light source 23B to be arranged outside of the housing 15, the degree of freedom in arrangement of the image display device 21B on the vehicle 1 can be improved. In the case of arranging the light source 23B outside of the housing 15, a heat sink 73 releasing heat of the light source element 41 may be arranged outside of the housing 15, with the result that the image display device 21B can include the heat sink 73 of a size enough to release heat of the light source element 41.

Between the light source element 41 and the condenser lens 24 in a pair and the collimate lens portion 65, the optical fiber 71 is arranged side by side in the first direction correspondingly to the light source element 41 and the condenser lens 24 in a pair.

[2-2. Effects, Etc.]

As above, the image display device 21B of this embodiment includes the optical fiber 71 that is arranged between the condenser lens 24 and the light guide panel 25 so that light from the condenser lens 24 propagates via the optical fiber 71 to the light guide panel 25.

This enables the amount of light incident on the eyebox Db to be increased. Besides, there can be provided the image display device 21B having the increased amount of light and the head-up display 11 mounted with the image display device 21B. Moreover, the light source 23 and the light guide panel 25 can be sufficiently spaced apart from each other so that heat of the light source 23 transmitted to the light guide panel 25 can be reduced.

The light source 23 includes the heat sink 73 that releases heat of the light source element 41. This enables use of the light source 23 with high power so that illuminance inside the eyebox Db can be further improved.

Referring then to FIG. 12, a first variant of the image display device of the second embodiment will be described. FIG. 12 is a partial enlarged sectional view of the image display device in the variant of the second embodiment. As shown in FIG. 12, in an image display device 21C, a pitch d2 between the exit openings 71b of the optical fibers 71, i.e., the pitch d2 between the plurality of collimate lenses 41b of the light guide panel 25 is smaller than a pitch Pt1 between the plurality of light source elements 41. Since use of the optical fibers 71 enables a reduction in pitch of light emitted from the light source elements 41, it is possible to deal with the image display device 21 and the light guide panel 25 that have been reduced in size, and to increase the density of light from the light source 23B.

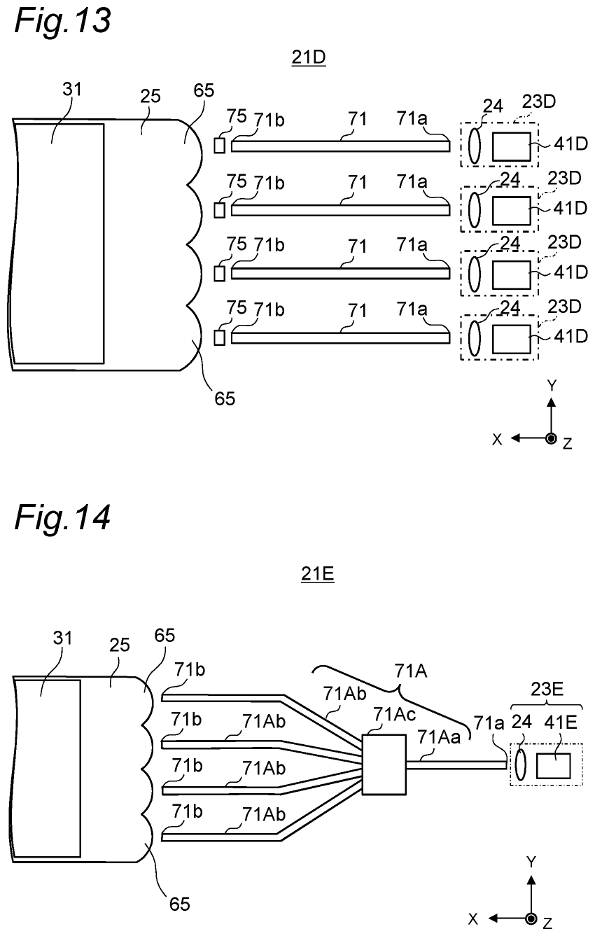

Referring then to FIG. 13, a second variant of the image display device of the second embodiment will be described. FIG. 13 is a partial enlarged sectional view of an image display device 21D in the second variant of the second embodiment. As shown in FIG. 13, the image display device 21D includes a fluorescent substance 75 arranged between the optical fiber 71 and the collimate lens portion 65 of the light guide panel 25, of the image display device 21B of the second embodiment. A light source element 41D of a light source 23D is a laser element that emits blue light, blue light emitted from which irradiates the fluorescent substance 75 via the optical fiber 71 so that yellow fluorescence is incident toward the light guide panel 25 together with blue light passing through the fluorescent substance 75. As a result, white light is irradiated on the light guide panel 25. Since only blue light can be used for the light source element 41D, high-power light can be emitted to further improve illuminance inside the eyebox Db.

Referring then to FIG. 14, a third variant of the image display device of the second embodiment will be described. FIG. 14 is a partial enlarged sectional view of an image display device 21E in the third variant of the second embodiment. As shown in FIG. 14, an optical fiber 71A of the image display device 21E includes a light-source-side optical fiber 71Aa, a branch coupler 71Ac, and exit-side optical fibers 71Ab. The optical fiber 71A branches from the single light-source-side optical fiber 71Aa toward the light source element 41E into the plurality of exit-side optical fibers 71Ab toward the light guide panel. The light-source-side optical fiber 71Aa is branched, for example, via the branch coupler 71Ac into the plurality of exit-side optical fibers 71Ab.

Light emitted from the light source element 41E is incident via the condenser lens 24 on the light-source-side optical fiber 71Aa and is branched by the branch coupler 71Ac to be separately propagated to the exit-side optical fibers 71A. Light emitted from the exit opening 71b of each of the exit-side optical fibers 71Ab is incident on the light guide panel 25. By using the optical fiber 71A that is branched on its exit side in this manner, the number of the light source elements 41E can be reduced, achieving miniaturization of the light source 23E.

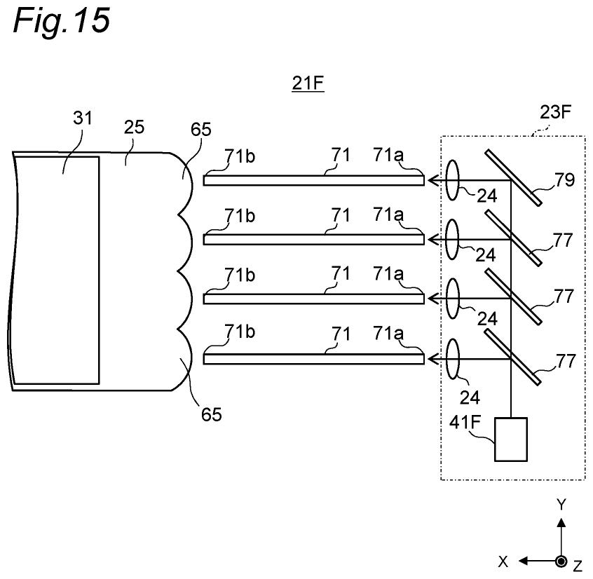

Referring then to FIG. 15, a fourth variant of the image display device of the second embodiment will be described. FIG. 15 is a partial enlarged sectional view of an image display device 21F in the fourth variant of the second embodiment. As shown in FIG. 15, the image display device 21F further includes half mirrors 77 that split light from a light source element 41F of a light source 23F, and a mirror 79 that totally reflects light from the light source element 41F.

The half mirrors 77 are each arranged on an optical path between the light source element 41F and the condenser lens 24, correspondingly to the optical fiber 71 and the condenser lens 24 that are arranged facing each of the collimate lens portions 65. The mirror 79 is arranged facing the condenser lens 24 that is farthest among the condenser lenses 24 on which light of the light source element 41F is incident. The reflectance of each of the half mirrors 77 is designed to increase in the ascending order of distance from the light source element 41F so that the amount of light of reflected light from the half mirrors 77 and the mirror 79 is the same.

Light emitted from the light source element 41F is split by the half mirrors 77 and is incident via the condenser lens 24 on the optical fiber 71. Light split by the half mirrors 77 multiple times is totally reflected by the mirror 79 to be incident on the optical fiber 71. By using the half mirrors 77 and the mirror 79 in this manner, the number of the light source elements 41F can be reduced, achieving miniaturization of the light source 23F.

As above, the first embodiment, the second embodiment, and the variants thereof have been described as exemplification of the techniques disclosed in this application. However, the techniques in the present disclosure are not limited thereto, and are applicable to any embodiments to which changes, permutations, additions, omissions have been made appropriately. New embodiments may be provided by combining constituent elements described in the first and second embodiments and the variants thereof. Thus, other embodiments will hereinafter be exemplified.

Although in the above embodiments, the TFT transmissive liquid crystal panel has been exemplified as the transmissive display panel 31, any other display element may be employed as long as it is a transmissive display device.

Although in the above embodiments, the light guide panel 25 and the display panel 31 are arranged in parallel, they may be arranged tilted relative to each other.

The movable body mounted with the head-up display 11 of the embodiments is not limited to vehicles such as automobiles, and includes railroad vehicles, motorcycles, aircraft, helicopters, vessels, and other various types of devices that transport persons.

As above, the embodiments have been described as exemplification of techniques in the present disclosure. To that end, the accompanying drawings and the detailed description have been provided.

Accordingly, the constituent elements described in the accompanying drawings and the detailed description may include not only constituent elements essential for solving the problems but also constituent elements not essential for solving the problems, for the purpose of exemplifying the above techniques. Hence, those unessential constituent elements should not be construed as essential directly from the fact that those unessential constituent elements are described in the accompanying drawings and the detailed description.

Since the above embodiments are for the purpose of exemplifying the techniques in the present disclosure, various changes, permutations, additions, omissions, etc. may be made within the scope of claims or within the range of equivalents thereof.

### Summary of Embodiments

(1) An image display device of the present disclosure includes: a light source having a light source element that irradiates light; a display panel that displays an image; and a light guide panel that guides light from the light source to the display panel. The light guide panel has a collimate lens portion that collimates light from the light source on an incident surface on which light from the light source is incident. A maximum spread angle θ at which light irradiated from the light source intersects with a main plane of the collimate lens portion is 15 degrees or more and 60 degrees or less, and light irradiated from the light source has a width less than one-third of the width of the main plane of the collimate lens portion.

Since this allows light with a small light-emitting surface from the light source to be incident on the light guide panel, the spread of light can be suppressed and the amount of light propagating inside the eyebox can be increased.

(2) In the image display device of (1), the light source has a plurality of the light source elements. The light guide panel has an incident surface that faces the light source, an exit surface that faces the display panel, and a bottom surface that faces the exit surface, opposite to the display panel. The incident surface is a lateral surface of the light guide panel, lying between the exit surface and the bottom surface. The exit surface has a rectangular shape composed of long sides and short sides, and, in plan view, the plurality of light source elements are arranged along the direction of the short sides of the exit surface.

(3) In the image display device of (1) or (2), the light source includes a condenser lens that condenses light irradiated from the light source element.

(4) In the image display device of (3), a light condensing position of light passing through the condenser lens, a positional offset amount Lpf from a focal position of the lens portion, and a focal length f of the lens portion satisfy a relational expression which follows:

−f/5<Lpf<f/5

(5) In the image display device of any one of (1) to (4), the light source element has a laser element.

(6) In the image display device of any one of (1) to (5), light irradiated from the light source has a width of 0.5 mm or less.

(7) In the image display device of (5), the laser element is arranged such that light from the laser element has a pupil diameter whose long-diameter direction corresponds to short-side direction of an eyebox that is a visibility area of the image.

(8) The image display device of any one of (1) to (7) includes: a light ray direction altering member that alters traveling direction of entire light leaving the light guide panel toward direction where the display panel lies; and a light orientation lens that, at central portion and peripheral portions of the light orientations lens, allows light from the light ray direction altering member to have different traveling directions with respect to the display panel.

(9) In the image display device of (4), a pitch d between the light source elements adjacent to each other, a length L from the light condensing position of light passing through the condenser lens to the collimate lens portion of the light guide panel, and a maximum spread angle θ of light from the light condensing position satisfy a relational expression which follows:

1.6·L·tan θ≤d≤2.0·L·tan θ

(10) In the image display device of (4) or (9), the light guide panel has a protruding portion that is in contact with an outer peripheral surface of the collimate lens portion and extends toward the light source.

(11) The image display device of any one of (1) to (8) includes an optical fiber arranged between the light source and the light guide panel, light from the light source propagating via the optical fiber to the light guide panel.

(12) In the image display device of (11), the light source is arranged apart via the optical fiber from the light guide panel, and the light source arranged apart from the light guide panel includes a heat sink that releases heat of the light source elements.

(13) In the image display device of (11) or (12), a pitch between exit openings of the optical fibers adjacent to each other is greater than that between adjacent ones of the light source elements.

(14) The image display device of (11) or (12) includes a fluorescent substance arranged between the optical fiber and the light guide panel, blue light being emitted from each of the light source elements, blue light from each of the light source elements irradiating the fluorescent substance to allow white light to be incident on the light guide panel.

(15) In the image display device of (11) or (12), a plurality of optical fibers toward the light guide panel are branched from a single optical fiber toward the light source element.

(16) The image display device of (3) includes: an optical fiber arranged between the light source and the light guide panel; and a half mirror arranged on an optical path between the light source element and the condenser lens, light from the light source propagating via the optical fiber to the light guide panel, light from the light source element being split by the half mirror, with split light being incident on the optical fiber.

(17) A head-up display including the image display device of any one of (1) to (16).

(18) A movable body including the head-up display of (17).

The present disclosure is applicable to an image display device. The present disclosure is applicable further to a head-up display including the image display device.

### EXPLANATIONS OF LETTERS OR NUMERALS

1 vehicle
3 windshield
11 head-up display
13 reflection optical unit
15 housing
17 first mirror
19 second mirror
21 image display device
23, 26 light source
24 condenser lens
25 light guide panel
27 specular reflection member
29 light ray direction altering member
30 light orientation lens
31 display panel
41 light source element
41a light emitting element
41b collimate lens
41aa pupil diameter
42 light source element
43 incident surface
45 exit surface
47 bottom surface
49 confronting surface
51 prism surface
51a prism
51b seat surface
51c slant surface
65 collimate lens portion
67 protruding portion
71, 71A optical fiber
71a opening
71b exit opening
71Aa light-source-side optical fiber
71Ab exit-side optical fiber
71Ac branch coupler
73 heat sink
75 fluorescent substance
77 half mirror
79 minor
Da observer
Db eyebox
F1 focal position
P1 light condensing position

What is claimed is:

1. An image display device comprising:
a light source having a light source element that irradiates light;
a display panel that displays an image; and
a light guide that guides light from the light source to the display panel,
the light guide having a lens portion that suppresses spread of light from the light source,
a maximum spread angle θ at which light irradiated from the light source intersects with a main plane of the lens portion being 15 degrees or more and 60 degrees or less,
light irradiated from the light source having a width less than one-third of the width of the main plane of the lens portion.

2. The image display device according to claim 1, wherein
the light source has a plurality of the light source elements, wherein
the light guide has an incident surface that faces the light source, an exit surface that faces the display panel, and a bottom surface that faces the exit surface, opposite to the display panel, wherein
the incident surface is a lateral surface of the light guide, lying between the exit surface and the bottom surface, wherein
the exit surface having a rectangular shape composed of long sides and short sides, and wherein in plan view, the plurality of light source elements are arranged along direction of the short sides of the exit surface.

3. The image display device according to claim 1, wherein
the light source comprises a condenser lens that condenses light irradiated from the light source element.

4. The image display device according to claim 3, wherein
a light condensing position of light passing through the condenser lens, a positional offset amount Lpf from a focal position of the lens portion, and a focal length f of the lens portion satisfy a relational expression which follows:
−f/5<Lpf<f/5.

5. The image display device according to claim 1, wherein
the light source element has a laser element.

6. The image display device according to claim 1, wherein
light irradiated from the light source has a width of 0.5 mm or less.

7. The image display device according to claim 5, wherein
the laser element is arranged such that light from the laser element has a pupil diameter whose long-diameter direction corresponds to short-side direction of an eyebox that is a visibility area of the image.

8. The image display device according to claim 1, comprising:
a light ray direction altering member that alters traveling direction of entire light leaving the light guide toward direction where the display panel lies; and
a light orientation lens that, at central portion and peripheral portions of the light orientation lens, allows light from the light ray direction altering member to have different traveling directions with respect to the display panel.

9. The image display device according to claim 4, wherein
a pitch d between the light source elements adjacent to each other, a length L from the light condensing position of light passing through the condenser lens to the lens portion of the light guide, and a maximum spread angle θ of light from the light condensing position satisfy a relational expression which follows:
1.6·L·tan θ≤d≤2.0·L·tan θ

10. The image display device according to claim 4, wherein
the light guide has a protruding portion that is in contact with an outer peripheral surface of the lens portion and extends toward the light source.

11. The image display device according to claim 1, comprising:
an optical fiber arranged between the light source and the light guide, wherein
light from the light source propagates via the optical fiber to the light guide.

12. The image display device according to claim 11, wherein
the light source is arranged apart via the optical fiber from the light guide, and wherein
the light source arranged apart from the light guide includes a heat sink that releases heat of the light source elements.

13. The image display device according to claim 11, wherein
a pitch between exit openings of the optical fibers adjacent to each other is smaller than a pitch between the light source elements adjacent to each other.

14. The image display device according to claim 11, comprising:
a fluorescent substance arranged between the optical fiber and the light guide, wherein
blue light is emitted from each of the light source elements, and wherein
blue light from each of the light source elements irradiates the fluorescent substance to allow white light to be incident on the light guide.

15. The image display device according to claim 11, wherein
a plurality of optical fibers toward the light guide are branched from a single optical fiber toward the light source element.

16. The image display device according to claim 3, comprising:
an optical fiber arranged between the light source and the light guide; and
a half mirror arranged on an optical path between the light source element and the condenser lens, wherein
light from the light source propagates via the optical fiber to the light guide, wherein
light from the light source element is split by the half mirror, and wherein
split light is incident on the optical fiber.

17. A head-up display comprising the image display device according to claim 1.

18. A movable body comprising the head-up display according to claim 17.
